(19) United States
(12) Patent Application Publication
(10) Pub. No.: US 2005/0288085 A1
(43) Pub. Date: Dec. 29, 2005

(54) Dealer identification system

(75) Inventors: Oliver M. Schubert, Las Vegas, NV (US); Justin G. Downs III, Henderson, NV (US)

Correspondence Address: Mark A. Litman & Associates, P.A.;York Business Center, Suite 205, 3209 West 76th St., Edina, MN, 55435, US

(73) Assignee: Shuffle Master, Inc.

(21) Appl. No.: 10/920,776

(22) Filed: Aug. 18, 2004

Related U.S. Application Data
(63) Continuation-in-part of application No. 10/880,410, filed on Jun. 28, 2004.

(51) Int. Cl. G06F 19/00; G06F 17/00

(52) U.S. Cl. 463/11

(57) ABSTRACT

Casino table card games are provided with sensors or readers for detection of information or a signal identifying a crew member (e.g., dealer, croupier, pit worker, etc.) at a specific casino table. The table has a component that reads information or receives a first signal from the card. The first signal is received or read from a card (e.g., by swiping the card, or receiving an RF or responsive signal) by a table subcomponent that has a time or time/dating capability. The first signal is time/date stamped (referred to herein as “Date Stamping” or “date stamping” for simplicity) when sent, when read or when received. The date stamped signal is then transmitted from the subcomponent to a processor (e.g., gaming table processor or pit processor or main casino processor and/or central processor for multiple casinos). The data retains its date stamping at least through storage, analysis, data entry or other treatment of the data after transmission away from the table, and the date stamping may or may not be provided by the sensor/reader/receiver itself. The system also allows for the date stamping or other status information to be sent to a data bank or repository of information (e.g., security bank or security room) for storage of the information, without necessarily any game-play related function. The data may be processed in real time at this bank or repository, or may me reviewed and analyzed at a later time.

### RELATED APPLICATION DATA

This application claims priority as a continuation-in-part of U.S. patent application Ser. No. 10/880,410, filed on Jun. 28, 2004 entitled APPARATUS FOR COUNTING ROUNDS OF PLAY IN A LIVE GAME OF CHANCE.

### BACKGROUND OF THE INVENTION

1. Field of the Invention

The present invention relates to the field of casino table games, casino table games with live dealers, and casinos where monitoring of play and employee performance is desired.

2. Background of the Art

Processing equipment and computers have become an increasingly important part of the gaming industry, but the introduction of the technology has been sporadic, inconsistent, and often ill designed. In addition, the direction of improvement in the processing apparatus used in casinos has consistently been heading in the direction that bigger and more powerful is better, attempting to mimic the home computer market. The original processors introduced into the market were hardwired, unique designs that performed all command functions from a central controlling processor or actually performed within a single computer that sent signals to all mechanical operating elements.

Traditional gaming devices are based around a main processor unit (which may include a random number generator), an accounting function operatively coupled to the main processor or embedded in the main processor, and more recently a processor or EPROM having stored therein the important gaming functions. In addition, these gaming devices include gaming displays, coin acceptors, player identity recognition, bill validation functions, ticket-in-ticket out controls and the like operatively coupled to the main processor. These casino table gaming devices and systems have been relatively simple and limited in scope, usually consisting of a few executing programs utilizing straight forward interrupt schemes and detection loops for asynchronous events for simple evaluation. There have been a simple external program validation devices that can be coupled to the EPROM or main processor (through a line connection or port) for providing effective regulatory validation of critical gaming functions to preclude unauthorized tampering or modification of the system through software. In addition, an external device validation process for suspicious results or disputes may be validated by simply reading the stored data that has been generated from the table gaming systems and associated with the main processor.

Today's trend in gaming devices is towards automation and an increasing utilization of LINUX or personal computer based gaming platforms. Personal computer based platforms are being employed by designers to make use of real time operating systems which allow for multi-threaded/multi-tasking processes and the use of many “off the shelf” device drivers.

There are a wide variety of associated devices that can be connected to or serve as part of a gaming machine such as a casino table gaming system. These devices provide gaming features that define or augment the game(s) played on the gaming machine. Some examples of these devices are player location or player order indicators, lights, ticket printers, card readers, speakers, bill validators, coin acceptors, display panels, key pads, and button pads. Many of these devices are built into the table or into associated components carried on the table. Often, a number of devices are grouped together in a separate box that is placed on top of the gaming table.

U.S. Pat. No. 6,071,190 (Weiss) describes a gaming device security system is disclosed which includes two processing areas linked together and communicating critical gaming functions via a security protocol wherein each transmitted gaming function includes a specific encrypted signature to be decoded and validated before being processed by either processing area. The two processing areas include a first processing area having a dynamic RAM and an open architecture design which is expandable without interfering or accessing critical gaming functions and a second “secure” processing area having a non-alterable memory for the storage of critical gaming functions therein.

Casino Table Games (such as blackjack, poker, varietal poker such as Let It Ride® poker, Three Card™ poker and Four-Card™ poker, baccarat, Casino War™ game, also require some security control, and more highly automated systems are being described in the literature and introduced to the marketplace. There are, for example, numerous U.S. Patents assigned to MindPlay LLC (e.g., U.S. Pat. Nos. 6,712,696; 6,688,979; 6,685,568; 6,663,490; 6,652,379; 6,638,161; 6,595,857; 6,579,181; 6,579,180; 6,533,662; 6,530,837; 6,530,836; 6,527,271; 6,520,857; 6,517,436; 6,517,435; and 6,460,848; and Published U.S. patent application No. 20030096645) describe systems and components of systems that are used to more fully automate casino table card games, and especially blackjack. These systems include card recognition devices, bet sensing devices (e.g., chip sensors and counters), software to evaluate the games as and after they are played, and the like.

U.S. Pat. No. 5,803,808 (Strisower) describes a device to be utilized in casino gaming that will count the number of “hands” (read “rounds”) of a given card game played per given period of time. The information is used by a database system within the casino to determine theoretical win/loss based upon historical and theoretical outcome data related to probability of winning/losing any given hand and then factoring in the number of hands (rounds) played. Preferably this device is polled by a database system to collect this information. In a preferred embodiment, the device could be utilized with an automatic tracking and information management system. The automatic tracking and information management system (ATMS) automatically determines various player transactions associated with a device in a gaming establishment. The ATMS includes an automatic tracking and management unit (ATMU) which transmits and receives information between all gaming tables in all pit areas and the gaming establishment database system. The ATMU provides for the interactive determination of various transactions within the pit area. Through the automatic tracking and management system the manual paper tracking, activities associated with the pit area are eliminated, thereby freeing pit personnel for other tasks. The device could also be generically connected to any tracking and information system through any standard serial interface.

Crown Casinos in Australia has recently provided a device that assists in counting rounds of play by using a card sensing component on a table that responds to the blockage of ambient light into a hole and the forwarding of the sensed data to a central computer. The data is logged in as it is received to indicate a time element associated with each piece of data received.

Various other U.S. Patents that include automation enhancing technology for casino table card games include U.S. Pat. Nos. 6,582,301; 6,299,536; 6,165,069; 6,117,012; 6,093,103; 6,039,650; 5,722,893; 5,605,334. As can be seen from these disclosure, the computing structural and component structures of gaming systems follows the traditional format of a main processor driving peripherals, and where one feature demands a significant amount of computing power, two processors may be added, with one processor still tending to be the dominant main processor sending commands to the peripherals. In proposed table systems, peripheral devices (such as a hand sensor or round counter or bet sensor provides the signal and sends the signal to the gaming table processor and/or to a main processor. These signals are sometimes logged in with a time stamp for noting when it was received and/or logged in. The systems in gaming table operations tend to be structured in the same manner, with systems described as comprising a main computer, central computer or the like, and various peripherals such as card readers, chip readers, cameras, lighting elements, shufflers, bet sensors, movement sensors, motion sensors, jackpot incrementers/decrementers, game status indicators (e.g., jackpot registers, blackjack indicators, symbol indicators and the like) and any other elements of the table game. Examples of such systems include method, apparatus and article for verifying card games, such as playing card distribution as described in U.S. Pat. Nos. 6,638,161; 6,595,857; 6,5,79,181; 6,579,180; 6,533,275; 6,530,837; 6,530,836; 6,527,271; 6,520,857; 6,517,436; 6,517,535; and 6,460,848 (the Soltys' patents). Other gaming table systems that operate on the basis of a central programmer commanding peripheral devices (that may or may not have some processing capability of their own) include U.S. Pat. Nos. 6,299,536 and 6,039,650 (Hill); U.S. Pat. No. 5,779,546 (Meissner)which describes touch screens and player entry features at each player position, U.S. Pat. Nos. 6,093,103 and 6,117,012 (McCrea) which describes card sensing systems at each player location as well a card reading shoes; and U.S. Pat. No. 6,126,166 (Lorson) describing a card control and recognition system and method, as represented by claim 1, which is shown directly below. U.S. Pat. No. 6,629,894 (Purton, Dolphin Advanced Technologies, Ltd.) describes a card inspection device including a first loading area adapted to receive one or more decks of playing cards. A drive roller is located adjacent the loading area and positioned to impinge on a card if a card were present in the loading area. The loading area has an exit through which cards are urged, one at a time, by a feed roller. A transport path extends from the loading area exit to a card accumulation area. The transport path is further defined by two pairs of transport rollers, one roller of each pair above the transport path and one roller of each pair below the transport path. A camera is located between the two pairs of transport rollers, and a processor governs the operation of a digital camera and the rollers. A printer produces a record of the device's operation based on an output of the processor, and a portion of the transport path is illuminated by one or more blue LEDs. A printer is also provided as part of the system driven by a central computer.

Published U.S. patent application No. 20040137977 discloses that in games employing a plurality of cards and chips, for example, the cards are exchanged between a dealer and players facing each other over a game table, and the chips according to bets are exchanged between the players through the dealer. A casino hotel is known as an establishment for playing such card games. In a casino hotel, a guest who has received a house card (e.g., an ID card on which an identification number is recorded to prove him/herself) upon check-in, in other words, a user of the casino hotel can utilize the house card to use different facilities in the hotel. The house card is read out at the cashiers in restaurants and bars in the hotel so that the bills are stored in a hotel server. Upon check-out, all the bills are displayed on the terminal at the front desk. In addition, the house card can be utilized in transportation outside the hotel during a stay by connecting the transportation to the hotel via network. As shown in FIGS. 2A and 2B, the first identification information detectors 30 for detecting the card identification information are provided in the vicinities of a dealer D and participants P1, P2, and P3 in the game on the game table 24.

U.S. Published patent application No. 20040128160 discloses that a chip identification information recording device 144 of the chip 128 comprises a subminiature wireless ID tag embedded in each chip 128. In the subminiature wireless ID tag, it is recorded the information connecting with the chip 128 such as value of the chip 128 in the card game (for example, 1 dollar, 5 dollars, 10 dollars), a specific number (the number identifying each chip 128) and the like. The identification information detecting devices 146, which detects the chip identification information recorded in the chip identification information recording device 144, are provided on the gaming table 68 near the dealer D and each of participants P1, P2, P3. The identification information detecting device 146 is constructed form an ID reading device and a measuring device 160. In the ID reading device, there are provided an X-axis transmitting antenna 150 and an X-axis receiving antenna 152 both of which are extended parallel with each other from an X-axis scanning driver 148, and a Y-axis transmitting antenna 156 and a Y-axis receiving antenna 158 both of which are extended parallel with each other from a Y-axis scanning driver 154 and arranged so as to cross the X-axis transmitting antenna 44 and the X-axis receiving antenna 46 at right angle. In the above ID reading device, in a case that the scanning wave is sent from the X-axis transmitting antenna 150 and the Y-axis transmitting antenna 156 under the state that the chip 128 is betted on the gaming table 68 (the identification information detecting device 146), the electric wave for reading is risen near the cross point of the antennae 150, 156. The electric wave for reading is received by the X-axis receiving antenna 152 and the Y-axis receiving antenna 158. At that time, if the chip 128 is betted (positioned) near the cross point, impedance is changed near the cross point based on that the chip 30 acts as dielectric substance, thereby wave receiving state in both the receiving antennae 152, 158 is changed. By detecting this changing state in wave receiving, it is detected whether the chip 128 exists or not. At the same time, the signal from the subminiature wireless ID tag 144 is received by the X-axis receiving antenna 152 and the Y-axis receiving antenna 158, thereby the chip information such as the value of the chip 128 (1 dollar, 5 dollars, 10 dollars) and the specific number (the number identifying each chip 128) is read out.

In Published U.S. patent applications Nos. 20020111205; and 20040087632, a display device 43 is comprised of touch sensitive monitor 43.01, keypad 43.02, mounting hardware 43.03 and indicator 43.08. Touch sensitive monitor 43.01 can be a Caltron Industries FPT-064 10 VGA open frame touch sensitive monitor available from Caltron Industries of Fremont, Calif., and generates audiovisual data relating to betting parameters associated with a particular table game, advertising, table game events according to game progression (such as the value of a die roll, a roulette result, or the occurrence of a large payout event) and player activity information derived by the system of the present invention. Touch sensitive monitor 43.01 and or a keypad also allow data to be input by players, dealers, or other suitable persons for use in a table game system. In one exemplary embodiment, keypad 43.02 can be configured so that a predetermined key can be associated with one or more suitable functions relating to the table game system.

In operation, paddle 48 is used to allow entry of data for use in a table game system. Paddle device 48 is configured to be readily integrated into an existing table game, such that dealer and player data can be obtained through data entry device 48.03. In this manner, paddle device 48 can be used to allow dealer and player data entry without the addition of other keyboard devices, data entry devices, or similar devices that may be unacceptable in certain environments. In operation, remote terminal 50 allows data to be generated for use in a game table system. Remote terminal 50 can be used to provide supervisory capabilities, and can be used by dealers, players, or in other suitable configurations. In one exemplary embodiment, remote terminal 50 allows a floor supervisor to enter data for a table game system in parallel with a dealer, such as to provide independent verification of user-entered data, such as player identification data, bet amount data, bet location data, game progression data (such as die roll data, card data, roulette ball data), or other suitable data. Notification data for the supervisor can be generated by a notification system if a discrepancy exists between data entered by the dealer and data entered by the supervisor. Likewise, player identification data, bet amount data, bet location data, game progression data and other suitable data that is automatically generated can be transmitted to remote terminal 50, such that the supervisor can use such automatically-generated data to monitor the progression of the game or dealer performance, can combine the automatically generated data with user-entered data to verify the automatically generated data or review dealer performance, or can perform other suitable functions. FIG. 26 is a diagram of a pedal device 47 in accordance with an exemplary embodiment of the present invention. Pedal device 47 includes one or more pedals, 47.01 through 47.04, which can be used by a dealer to discreetly enter control data. In one exemplary embodiment, the dealer can indicate to a supervisor or other personnel that assistance is required, such as where activation of one or more of the pedals can cause an indicator on the supervisor's display, a light such as alerting LED 41.11, or other suitable indicators to be activated. In another exemplary embodiment, activation of one or more pedals can cause a display to be activated, such as indicating the occurrence of blackjack, a roulette game payout, a craps dice position, or other suitable data. Pedals 47.01 through 47.04 can also be used in combination, such as by allowing the dealer to activate two pedals, such as one with each foot. In this manner, the four pedals shown can result in ten different control indications.

Published U.S. patent application No. 20040029087 describes systems that are based in an electronic environment that includes logic processors and circuitry such as are found in desktop computers, laptop computers, palmtop computers, hand held devices, kiosks, network terminals, interactive video systems and similar products. The electronic system executes software routines that can be locally or remotely stored. The software routines commonly consist of five logical program blocks including: 1) a user identification block; 2) a communication block; 3) a training block; 4) a scoring block; and 5) an administrative block. The blocks may be combined or subdivided in any given program or set of programs without substantially changing the claimed systems. Further, each block is commonly comprised of multiple subroutines that have an association with the general function of the block. For example, the function of the training block is to present tutorials and examinations to a user/trainee for a variety of games of chance. The specific game or games of chance present in any particular system will depend on the unique needs of the system operator and the trainees who will be using the system. The function of the user identification block is to condition access to the training system, and to record a history of interaction with the system that is unique to each user. This block may also provide higher level access to the system for various administrative tasks that may include security settings, content editing, data storage and retrieval, and other supervisory tasks. The identification block may also be used as a timekeeping system that records things such as the amount of time spent using the system or as an electronic time clock that records the check in and check out time for each employee.

Published U.S. patent application No. 20030232651 discloses a system for allowing a remote player to play a live casino table game having a live casino table game interface for collecting live play data about a play of the table game, a player console located away from the live casino table game for collecting bet data from a remote player, a game controller connected to the player console and to the game interface for collecting the bet data and the live play data to credit and debit an account of the remote player as a function of wins and losses according to rules of play, and a video system providing a video display of the live casino table game to the remote player. The live play data includes game play data of at least one of the players and the dealer playing the live casino table game, and the bet data defines a simplified betting option including a game achievement status of a player or dealer involved in the live casino table game. The game achievement status may be a win/lose status for each play of the live casino table game. The game controller may calculate odds for the simplified betting option as a function of the live play data. Preferably, the simplified betting option is maintained automatically for a plurality of plays of the live casino table game.

Published U.S. patent application No. 20030211883 enables a customer to obtain cash or other negotiable instrument to continue playing at the gaming station. With this in mind, a portable RCU is provided to the customer at the gaming station. For example, where the gaming station is a card table, the portable RCU can be located on the table itself, or can be stored within arm's reach of an attendant (e.g., dealer, pit boss, etc.) who then provides the portable RCU to the customer. Alternatively, casino “runners” are normally dispersed throughout the casino who constantly walk about the casino, and are available to assist customers. With this in mind, where the customer is located at a discrete gaming station (e.g., slot machine, video poker, etc.), the runner or other casino personnel can hand deliver the portable RCU to the customer. Regardless, the customer is not required to exit or otherwise leave the gaming station to access or interact with the portable RCU.

Published U.S. patent application No. 20030027635 enables a player to be identified by a representative. For example, a representative may use a PDA to identify a player to the central computer. In various embodiments, representatives include, but are not limited to casino hosts, pit bosses, cocktail waitresses, coin changers, card dealers, cashiers, other casino employees, bus drivers and flight attendants. Methods of identifying a player include indicating (i) the player's name, (ii) the player's identification number (e.g., from a tracking card); (iii) a contact identifier for the player (e.g., the player's cell phone number, email address, credit card number, hotel room, or postal address); (iv) indicating a gaming device that is being operated by the player (e.g., the player at a specific slot machine); (v) the player's location—for example, a representative's PDA may have a built-in global position system (GPS) where the location of a player may be determined based on an indication of the player's location relative to the representative's PDA (e.g., “Twenty feet in front of me”); (vi) a sufficient number of characteristics of the player to identify him relative to other players in the area (e.g., male, gray hair, slightly balding, mustache, wearing a red and white Hawaiian-print shirt, smoking cigar, drinking margarita); (vii) an activity being performed by the player (e.g., the player operating the ATM machine); and/or (viii) a biometric of the player (e.g., a scan of the player's fingerprint, a photograph of the player). A player may be identified using a combination of the above or other methods. For example, a representative may identify, “the red-haired player sitting at the bank of slot machines thirty meters in front of me.”

Published U.S. patent application No. 20030002937 enables tracking of the efficiency of casino staff associated with each play of the game of chance. Specifically, a dealer ID and a Pit ID are stored as a part of data together with Players IDs for both the physical and remote players. For each player, an available stake and wager amount is also associated with each game ID. The stake amount must be verified prior to each wager being accepted because the player may be playing at more than one game of chance. Performance monitor data comprises data useful for managing casino operations. More specifically, data includes casino staff member IDs, an average rate of play rating for the staff members conducting the game of chance, for example, the dealers, bankers, croupier, pit bosses, a summary of how well the casino staff conducts the game and the number of players served at the table. A portion of the performance monitor data includes information that is useful for providing a high level of customer service, such as efficiently approving and providing casino comps, and for marketing new games and services to the players. Finally, performance monitor data also includes real-time accounting information that is useful for determining profit or loss for each table for each game or for a period of time. The present invention further includes a method for determining a profile for each dealer (or casino staff) and for updating said profile for each dealer (or casino staff) in real-time.

Published U.S. patent application No. 200200151352 enables the dealer performance to be assessed. The data required for assessing the players' turnover and the dealer performance is acquired in a relatively simple and reliable manner that does not place an extreme burden on the dealer. The monitoring of the table games takes place in such a way that the performance of a croupier or dealer, i.e., the value of his gaming proceeds, is detected. For this purpose, the so-called “table inventory” must be observed and recorded. The supply of gaming chips or simply “chips” which are located with most game types in the chip tray within the reach of the dealer, and the cash of the “drop box” in which the payments are deposited when purchasing chips. The chip tray automatically determines the supply of chips at the gaming table. All non-game dependent changes in the chip inventory, such as chip movements from the chip bank to the table and back: “Fills” and “Credits”, “Markers” for the handing out of chips to players in exchange for in-house checks are passed on to the data processing system manually via the input terminal 100. The cash present in the “Drop box” is determined by summing up the “drops” (the deposits for each sale of chips by the dealer). To determine the performance of each individual croupier, dealer, or table team, the table inventory must be determined for each change of the croupier, dealer, or team (dealer change). If such a dealer change is effected, then the new dealer identifies himself at the table terminal, for example by means of his magnetic card, i.e., advises the data processing system of the change. Thus, the takings of each dealer can be calculated.

Published U.S. patent application No. 20010132664 describes a player identification system wherein a portable instrument is issued to each person, each instrument including means for issuing an external, identifiable, electromagnetic signal. For example the instrument may be a card that includes a battery powered transponder or transmitter adapted to, in the case of a transponder card when prompted, send a discrete, coded, electromagnetic or ultrasonic signal of limited range. For a transponding card, a stationary transmitter/receiver sends an interrogating signal to induce the portable card transponder to transmit its coded electromagnetic signal that is received by the stationary transmitter/receiver. For a transmitting card, the card at timed intervals issues it's coded electromagnetic signal to be received by a the receiver. The stationary transmitter/receiver decodes the transponding signals into data signals corresponding to the individual card to validate its authenticity and to correlate the signal with a corresponding player account number. In the preferred embodiments the card and stationary antennae preferably employ “BLUETOOTH™” wireless data transmission protocols and standards as is presently known in the art.

Published U.S. patent application No. 20020103027 describes portable transaction devices that automatically signal to a receiver.

U.S. Published patent application No. 20010016202 describes accommodating table play such as play by players at Blackjack tables or crap tables or in sports wagering facilities to track the activity of the player playing these games. In those instances, the player would present their player tracking card to the dealer or other casino staff who would present their card to a local card reader and, in a known fashion, input average wager and time of play data and the like for purposes of tracking the player's play. This data is sent to a local server to be allocated to the player's account.

U.S. Pat. No. 6,733,388; 6,506,115; and 6,283,856 (Mothwurf) describes that the performance figures per virtue are combined into a croupier score with a breakdown of individual scores per segment. Data are captured from every dealer work period of in average 45 minutes a dealer works at a table between breaks. U.S. Pat. No. 6,629,889 (Mothwurf) describes other player tracking functions in other casino games U.S. Pat. No. 6,446,864 describes a system for automatically monitoring and tracking dealers located at gaming tables in a gaming facility using a wireless communications network, the system comprising: a portable data-carrying device; a table module provided near the dealer on the gaming table, the table module including a plurality of call buttons, a chip sensing mechanism, a reading unit and a signal processing means, for generating service call data, dealer-associated data and chip-associated data, wherein each chip has an unique color representing a denomination thereof; means connected to the table module via the network, for receiving two types of the data generated from the table module, storing them in a first and second databases, determining the performance of the dealer and estimating a revenue of the gaming facility, based on the stored data; and means connected to the table module via the network, for receiving the remaining type of the data generated from the table module, and displaying same on a screen. The system may have the reading means reads out an identification code of the dealer contained in the portable data carrying device; and the signal processing means processes the service call data, the dealer-associated data and the chip-associated data, stores them in a memory and transmits the same via the network. A card reader 130 is provided on the surface of the table module 100, which is used for checking information on whether a dealer takes his or her place on the table or moves away form the table to another table. Specifically, when the dealer inserts his or her identification (“ID”) card into the card reader on a gaming table in the gaming facility, the card reader reads out the identification card inserted, detects an ID code of the dealer and transmits the ID code together with a card insertion time to the host computer under the control of the CPU shown in FIG. 2. The ID code and the card insertion time also are stored into the first memory. Likewise, after the termination of the game, the dealer again inserts his ID card into the card reader and then moves to another gaming table in the gaming facility. When the ID card is again inserted into the card reader of the table to which the dealer moved, the table module 100 transmits the ID code of the dealer and the card insertion time at which the dealer's card is again inserted into the card reader to the host computer, together with chip-associated data previously contained in the first memory. The second memory stores therein an operating system program.

The above described references are incorporated herein by reference in their entirety as providing background technology that may be incorporated into the use of the claims technology of this Patent.

### SUMMARY OF THE INVENTION

Casino table card games are provided with sensors or readers for detection of information or a signal identifying a crew member (e.g., dealer, croupier, pit worker, etc.) at a specific casino table. The table has a component that reads information or receives a first signal from the card. The first signal is received or read from a card (e.g., by swiping the card, or receiving an RF or responsive signal) by a table subcomponent that has a time or time/dating capability. The first signal is time/date stamped (referred to herein as “Date Stamping” or “date stamping” for simplicity) when sent, when read or when received. The date stamped signal is then transmitted from the subcomponent to a processor (e.g., gaming table processor or pit processor or main casino processor and/or central processor for multiple casinos). The data retains its date stamping at least through storage, analysis, data entry or other treatment of the data after transmission away from the table, and the date stamping may or may not be provided by the sensor/reader/receiver itself. The system also allows for the date stamping or other status information to be sent to a data bank or repository of information (e.g., security bank or security room) for storage of the information, without necessarily any game-play related function. The data may be processed in real time at this bank or repository, or may me reviewed and analyzed at a later time.

### BRIEF DESCRIPTION OF THE FIGURES

FIG. 1 shows a schematic of casino table card game arrangement with sensor/reader/receiver, intermediate date stamping component and subsequent information flow in a casino table card gaming apparatus.

FIG. 2 shows a schematic of data transmission in the system of FIG. 1.

### DETAILED DESCRIPTION OF THE INVENTION

A casino table card gaming system communicates a message from a first subcomponent that receives casino employee identification information without date stamping. The casino employee identification information or data is transmitted to a first component that date stamps the signal. The first component forwards the date stamped signal to a memory component that stores the date stamped signal. The system comprises at least a casino table, a casino employee identification component, a casino employee identification data receiver that sends an undated signal, and the first component that receives the undated signal. The system may provide the data receiver as an employee identification card reader. The first component may, by way of non-limiting examples, comprise a chipboard, responsive electronics, broadcasting system, magnetic reader, optical reader/scanner, bar code reader, broadcast receiver, and the like. The first component need not have to store signals or data contained in the signals after date stamping and forwarding the signals. The system data receiver may detect electromagnetic signals. The date stamped signals may be then received by a central computer that creates data relating to location of a casino employee with respect to at least one specific casino table. A method is disclosed for detecting the location of a specific casino employee with respect to a specific casino table by automatically providing an original signal indicative of a casino table employee with respect to location of that casino table employee and the specific casino table, sending that signal without date stamping thereon to a first component on the table, the component date stamping the signal and then forwarding a date stamped signal to a memory component. The memory component may provide stored signal information to a processor that interprets received date stamped signals to compute the location of a specific casino employee and a length of time that employee is present at the specific casino table, the time being based upon use of the date stamping received. The original signal may contain no indication of date or time thereon. The original signal may provided by emitted electromagnetic radiation. The original signal may be electromechanically read from a card carrying casino employee identification data. The method may include the processor determining changes of casino employee at the specific casino table, at least in part based upon evaluation of a time component in date stamped data the processor receives. The results of play of a game at a specific casino table may be compiled in association with at least one specific casino employee at the specific table as part of an employee rating process. A hardware component is described for use on a casino card able that receives casino employee identification signals associated with a specific casino table without time stamped information thereon, adds time stamped information to the signals, and forwards the time stamped signal to a memory storage component. The hardware component may be constructed so that it cannot store time stamped signals after forwarding the time stamped signals.

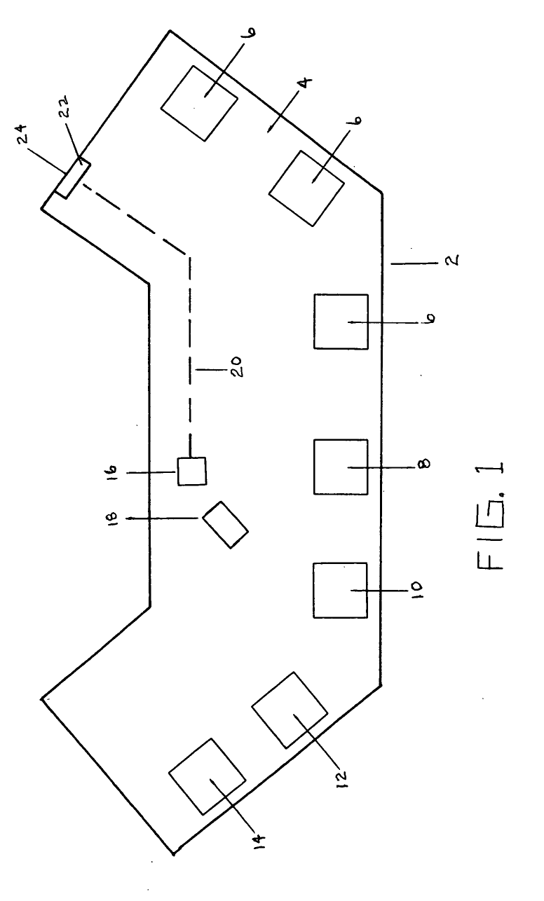

FIG. 1 shows a casino card gaming table 2. The Table 2 has a surface 4 with seven player positions 6 (three positions labeled 6), 8 10, 12 and 14 thereon. A subcomponent 16 that is capable of receiving dealer information and transmitting a first signal is provided in an area that may be adjacent to the dealer cards 18 or may be located somewhere else associated with the table that is within a signal receiving or data card reading distance from the dealer (not shown). The subcomponent 16 is connected by a communication system (preferably a wire system, but RF or other wireless systems could be used) to a rabbit 22 for the table 2. The rabbit 22 is on a communication line 24 to a data collector (not shown).

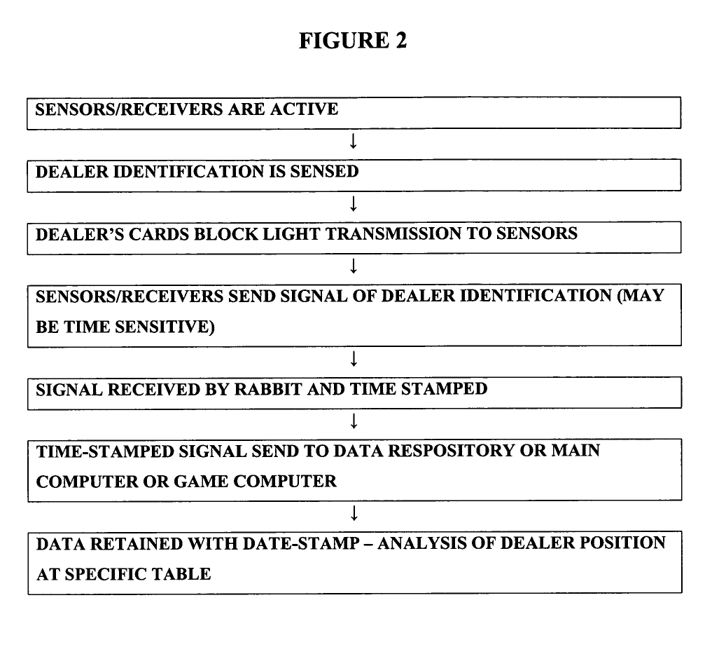

FIG. 2 shows a schematic of data transmission in the system of FIG. 1.

A concept of operative control among processing units should be appreciated to appreciate the performance of the present technology. It is believed that existing systems perform by a single main processor sending commands to peripherals to perform specific functions, and that date stamping is usually done at point of receipt of the data by a gaming processor, especially the main processor. For purposes of discussion, the initial main emphasis of the description will be directed towards the performance of casino table card games with a live dealer, but the system is equally applicable to the use of a fully automated (live dealer-less) gaming apparatus. This emphasis is not intended to narrow the scope of the invention, but is rather intended to simplify the description.

In a standard casino table card game, different events are sensed (usually visually by a live dealer and/or combinations of video cameras and personnel who review images from the video cameras and the system provides information from these observations. Where there is automated review of information (provided by manual or automatic input), a central processor evaluates this information and commands another element to perform a procedure or initiates a sequential event, including an analytic review of data or providing an alarm or message/report relating to analysis of the data or in response to identification of meaningful data. For example, a coin or token or chip is deposited in the coin receptor or in a bet sensing region viewed by cameras or detectors, the coin is sensed in the coin acceptor and a signal is sent to the main processor that a coin has been received. The main processor receives this information and sends a signal to the credit display or other accounting function to indicate that one credit should be displayed or provides ongoing information on playing wagering that Player X has wagered Y tokens. An additional signal is sent to any wager award control that identifies what wagers have been made, how much has been wagered, and what the theoretic awards could be based on that wager. Prior to this command from the main processor, the game play capability for that player was inactive. When a second token or coin is inserted, the same event happens between the coin acceptor, the processor and the credit display and award tracking, with the command now being to display two available credits. The processor knows not to send a separate activation notice to the Start button. When the player performs a task that indicates that a wager has been placed and the system identifies this task performance, a signal may be sent to the game control function within the main processor to register the amount of the wager. When the a start button is pressed or a start function initiated by a dealer or automated virtual dealer, a signal is sent to the main processor which then sends a signal to the game processor to initiate play of a game. Signals are sent from the main processor to the table game control system and the game play (which may in more automated systems be driven by a random number generator) to perform the tasks necessary to effect a play event. This could be as little as indicating to a dealer that the game is ready for dealing. The cards or the random number generator provides the results to or within the main processor (or a more local game table controller or pit game controller) and the main processor or other processor identifies the cards or other symbols to be provided in the play of the game (or which symbols have been dealt, by reading values, suits, ranks, etc. of cards dealt) and determines the existence of the status of the wager (win, lose or draw). In the event that the processor is used to determine whether a winning event has occurred, the processor then signals the credit display to indicate the total amount of credits won and commands the system to display or otherwise identify any winning alerts and the like. As can be seen from this analysis, the individual peripherals send signals to the main processor and the main processor provides specific commands to the various peripherals that specific functions are to be performed. There are a couple of concepts that are of interest to consider in this performance. First, a fairly sophisticated and powerful processor is needed to control all of the peripherals, such as a PC grade processor. Second, the processor must order events to send out separate signals to each of the peripherals, slowing down game performance. Any slow down in receipt of data may affect the value and treatment of data, including round counting functions.

As noted above, there are many different elements of the gaming system that can be considered as peripherals. Another listing of these components would include (in addition to those described above) are multimedia processing, stepper motor control, random number generation, card reading, hand reading (ranking), player strategy review/analysis, I/O detection and response, audio signals, video signals, currency handling, coin acceptors, bill acceptors, paperless transactions, ticket-in and ticket-out crediting, security systems, player accounting functions, door locks, player input (e.g., button controls, joy sticks, touch screens, service calls, etc.) and any other functions that my be provided on the table gaming apparatus.

The units or subcomponents on the gaming table or within the table gaming system can be operated substantially independently of each other, although some interdependencies may exist. In most systems substantially all performance of the peripheries is done only at the command of the gaming control processor or central computer.

Some game devices such as motors, player identification acceptors, etc., require a real time (RT) operating system (OS) to handle events in a timely fashion. An RTOS operation often adversely effects more traditional OS needs such as multimedia requirements. Ideally, separating the RTOS from the multimedia frees the multimedia system resources. Additionally, separating the multimedia control from the RTOS will eliminate the version dependencies created by coupling unique RTOS to the multimedia OS.

As noted earlier, round counting is one service or data component that can be important to a table. For example, round completion can be important for evaluating rates of play at tables, player rate performance, dealer rate performance, and even disputes over time of completion of hands at different tables or different casinos where priority might be an issue (as in competitive events or qualifying events).

The dealer must make communication with the subcomponent 16 before dealing begins. The communication may be a transmitted or responsive signal from a dealer identification card to a receiver on the table, or may be effected by swiping a dealer identification card through a card reading machine. The dealer identification data can become a first signal on any of these bases. The reader/receiver may or may not directly date stamp the identification, and preferably the reader/receiver will not date stamp the identification, but rather the identification signal (the first signal) will be sent to the rabbit, which will date stamp the identification data and forward it to a processor. The game processor, table processor or main processor can poll the signal stamping component on a regular basis or wait for a signal or state change information to be received before it acts. By having the date stamping on the original signals at the table before being sent to any computer that analyzes or tabulates or permanently stores the information, a good level of quality information is maintained.

Particularly in games where there are multiple casino employees at a table, such as craps table or roulette table, the signal could also be originated by individual employee cards that contain chips or coils that send their own transmitted signals or respond to RF, IR, or other electromagnetic radiation scanning to provide the response. The card could also be required to be swiped or inserted into a reading system (e.g., reading an intelligent chip or data entry on the card). The card would enable a signal to be sent (e.g., by the reader/receiver to the date stamping component on the table. The dealer could even activate or press a button provided on the table to assure transmission of a transmitted signal from the dealer identification card, but this would tend to leave the results under the control of the dealer, which could be manipulated by the dealer to improve results on dealer play or results, or could suffer from forgetfulness.

The application of this technology to gaming tables follows similar architecture and application of design and performance. Gaming tables would include typical casino tables such as those used for blackjack (Twenty-One), baccarat, roulette, poker, poker variants (Let It Ride® poker, Three-Card Poker® game, Caribbean Stud® poker, etc.), craps, and the like. Many of these latter systems as they are being installed in casinos with advanced table technology, unless they are completely electronic without any physical implementation (such as physical playing cards, dice, spinning wheel, drop ball, etc.), will need sensing and/or reading equipment (e.g., card reading for suits and/or rank, bet reading sensors, ball position sensors, dice reading sensors, player card readers, dealer input sensors, player input systems, and the like. These would be the peripherals in the table systems. Also, newer capabilities are enabled such as moisture detection (e.g., for spilled drinks), smoke detection, infrared ink detection (to avoid card marking), shuffler operation, dealer shoe operation, discard rack operation, jackpot meters, side bet detectors, biometric identifying systems and the like.

The signals and information, when date stamped, do not have to be sent directly, indirectly or even eventually to a main game computer. The term “time stamping” is meant any relatable time entry, such as just time, all the way to time and date. The “time” does not even have to be actual local or standard time of day, but can be time from when machines are turned on, when dealers reached their assigned tables, when shifts begin, or when dealing starts at a table, etc. As the date stamping of some information, such as the counting of rounds, number of shuffles per hour, number of rounds per shuffle, and the like do not have any direct and underlying effect on the play of individual rounds of the game, the information may be sent to a data bank or information repository directly from each table (e.g., on a network directly from tables, through a table computer, or central networked computer, etc.). The information need not even be directly sent to a specific repository, but can be placed on a network as information status (as well as a specific signal or data package) such that when it is received by the data bank or storage repository, the recipient memory device will appropriately log-in and/or store the data or signal that is received from each table. This information can be analyzed and stored in real time or stored for later analysis upon command or upon regular intervals.

A G-Mod is a game module that supports specific functions on the gaming table or associated peripherals (e.g., shuffler). To understand a G-mod and its function, it is desirable to understand the concept of operative control among processing units. It is believed that existing systems perform by a single main processor sending commands to peripherals to perform specific functions, and that date stamping is usually done at point of receipt of the data by a gaming processor, especially the main processor. For purposes of discussion, the initial main emphasis of the description will be directed towards the performance of casino table card games with a live dealer. This emphasis is not intended to narrow the scope of the invention, but is rather intended to simplify the description. A G-Mod is an electronic hardware element that performs its task independent of direct control from a main processor. The device may have sufficient intelligence to read data and make a decision on data, but its primary task is not to receive and obey commands. For example, it may receive status signals or status data and determine whether it is to respond to the signal or data, but is not commanded by the data. Equally importantly, it is capable of sending out status data and/or signal data.

In a standard casino table card game, different events are sensed (usually visually by a live dealer and/or combinations of video cameras and personnel who review images from the video cameras and the system provides information from these observations. Where there is automated review of information (provided by manual or automatic input), a central processor evaluates this information and commands another element to perform a procedure or initiates a sequential event, including an analytic review of data or providing an alarm or message/report relating to analysis of the data or in response to identification of meaningful data. For example, a coin or token or chip is deposited in the coin receptor or in a bet sensing region viewed by cameras or detectors, the coin is sensed in the coin acceptor and a signal is sent to the main processor that a coin has been received. The main processor receives this information and sends a signal to the credit display or other accounting function to indicate that one credit should be displayed or provides ongoing information on playing wagering that Player X has wagered Y tokens. An additional signal is sent to any wager award control that identifies what wagers have been made, how much has been wagered, and what the theoretic awards could be based on that wager. Prior to this command from the main processor, the game play capability for that player was inactive. When a second token or coin is inserted, the same event happens between the coin acceptor, the processor and the credit display and award tracking, with the command now being to display two available credits. The processor knows not to send a separate activation notice to the Start button. When the player performs a task that indicates that a wager has been placed and the system identifies this task performance, a signal may be sent to the game control function within the main processor to register the amount of the wager. When the a start button is pressed or a start function initiated by a dealer or automated virtual dealer, a signal is sent to the main processor which then sends a signal to the game processor to initiate play of a game. Signals are sent from the main processor to the table game control system and the game play (which may in more automated systems be driven by a random number generator) to perform the tasks necessary to effect a play event. This could be as little as indicating to a dealer that the game is ready for dealing. The cards or the random number generator provides the results to or within the main processor (or a more local game table controller or pit game controller) and the main processor or other processor identifies the cards or other symbols to be provided in the play of the game (or which symbols have been dealt, by reading values, suits, ranks, etc. of cards dealt) and determines the existence of the status of the wager (win, lose or draw). In the event that the processor is used to determine whether a winning event has occurred, the processor then signals the credit display to indicate the total amount of credits won and commands the system to display or otherwise identify any winning alerts and the like. As can be seen from this analysis, the individual peripherals send signals to the main processor and the main processor provides specific commands to the various peripherals that specific functions are to be performed. There are a couple of concepts that are of interest to consider in this performance. First, a fairly sophisticated and powerful processor is needed to control all of the peripherals, such as a PC grade processor. Second, the processor must order events to send out separate signals to each of the peripherals, slowing down game performance. Any slow down in receipt of data may affect the value and treatment of data, including round counting functions.

As noted above, there are many different elements of the gaming system that can be considered as peripherals. Another listing of these components would include (in addition to those described above) are multimedia processing, stepper motor control, random number generation, card reading, hand reading (ranking), player strategy review/analysis, I/O detection and response, audio signals, video signals, currency handling, coin acceptors, bill acceptors, paperless transactions, ticket-in and ticket-out crediting, security systems, player accounting functions, door locks, player input (e.g., button controls, joy sticks, touch screens, service calls, etc.) and any other functions that my be provided on the table gaming apparatus. Some of the G-Mods may have more than one function associated with them, and some may have no game function to them, but only peripheral function.

The units or subcomponents on the gaming table or within the table gaming system can be operated substantially independently of each other, although some interdependencies may exist. In most systems substantially all performance of the peripheries is done only at the command of the gaming control processor or central computer.

One such format of use of this information would be for each table to have a rabbit receive the original signal from the dealer's card sensor, preferably date stamp the signal and broadcast that signal, e.g., wireless electromagnetic radiation signal or over a direct line or network to an information repository or data bank. The data bank would periodically (or immediately) evaluate the data in that signal, determine the identity of the casino employee at the table and enter that formal data into a database. There could be an immediate or periodic review of the data by software so that anomalies can be identified and reported appropriately.

Although the present invention has been described largely in terms of a single employee identification module that sends date-stamped information to a central database, other modules also could send data to the same database.

For example, a blackjack gaming table could be equipped with a round counting sensor (which may not be a G-Mod) and G-Mod may also be equipped with a sensor at the output of the dealing shoe for counting cards dispensed from the shoe. This information can be used in combination with the round counting information to deduce the number of cards dealt in a given round of play. If one counts the number (and possibly value) or cards coming out of the shoe, one can also determine or estimate the number of players at the table. If there are bet present sensors (and associated or non-associated G-Mod(s)) for the bet sensors, the number of hands played per round of play (e.g., the number of players) can be determined.

Each G-Mod is collecting, date stamping and transmitting data as the data is collected from the table to a central database, but none of the G-Mods are in communication with each other, and the database does not issue commands to the G-Mods. In effect, each G-Mod is a freestanding microprocessor that runs independently of the any other intelligence.

A card swipe module could be added to the table system as the dealer/casino employee identifier, with or without an associated G-Mod in the reader, or with the rabbit. This G-Mod could not only transmit time-stamped dealer identification data to the data repository, but could also transmit player I.D. information to the player tracking system residing in the casino computer system. The dealer I.D. would enable the processor to link a specific dealer to a specific table and to evaluate the specific dealer while the dealer was at that table. With the use of relief dealers, shift changes, crew rotation at craps tables, and the like, the need for immediate casino employee tracking becomes an important part of casino security.

Other alternative equipment could be in the form of one or more sensors could sense information transmitted through an output data port of a shuffler, for example, or a keypad control used to issue commands to a shuffler. The shuffler would have its own G-Mod and would be capable of transmitting date stamped information such as number of cards per hand, number of hands per hour, number of cards dispensed per unit time, number of player positions occupied, number of cards re-fed into a continuous shuffler per unit of time, number of promotional cards dispensed per unit of time, bonus awards granted at a certain time, and the like. This information could be collected in a central database, data bank or information repository (e.g., any electronic memory or storage system).

A bet interface module could also be provided. Known techniques for measuring wagers include optical and metal detection type bet present sensors for fixed bets, and camera imaging, radio frequency/identification technology and the like for measuring the amount of the bet, as well as the presence of the bet. Outputs from these measurement devices are fed through a dedicated G-Mod and the data is date stamped and delivered to the central data depository.

Another possible G-Mod could control a card reading camera located in either the card shuffler, the dealing shoe, the discard tray or combinations of the above. Information about the specific cards dealt to each player could be obtained by feeding date-stamped information about cards dealt and returned. In one form of the invention, the G-Mod sends date-stamped information to the database and an algorithm residing in the same computer or house computer uses this information as well as round counting and betting information to determine the composition of a hand of blackjack, for example.

Another separate G-Mod might be in communication with an identification system for tracking the movement of employees in and out of the pit (as opposed to at a specific table), even though it is more preferably used to identify when the dealers arrive at and leave the table. This information could be collected and reported along with rounds of play per hour to determine which dealers deal the most hands in a given period of time.

In a roulette application, a sensor and associated G-Mod can record the number of spins of the wheel in a unit of time, for example. This information could be associated with the player swipe card information from another G-Mod by merely comparing the time stamping of the data to determine how long a particular player stayed at a table. A sensor or G-Mod may “listen in” to communication to the reader board on a roulette table, and send that information to a data bank, so that a distinct sensor is not needed to read the position of the ball separate from existing components.

It is important to note that none of the G-Mod's are in communication (e.g., direct communication or command, although data or signal transmission from one G-Mod may pass through the communication network of one or more other G-Mods, without the signal being a command to any other G-Mod) with other G-Mods on the same gaming table. Also, the data repository does not issue commands to the G-Mods. The central database merely organizes the data in a manner that allows for easy access by external or other associated computers or another application program residing on the same computer as the database. In this respect, the G-Mod's are self-executing and do not require central intelligence to perform their individual functions. The data may be analyzed and used to make decisions about comping players, promoting pit personnel, closing and opening tables, determining optimal betting limits for given periods of time and other important managerial functions.

Each G-Mod may be in data communication with an interface device such as one or more specialized circuit boards to allow the data from multiple G-Mod's to be fed into a standard port of the computer that serves as the data repository.

A software interface can be provided to directly access data in the data repository and to manipulate and organize the data so that it can be outputted onto a display, written report or data stream so that the data can be interpreted. In one preferred software interface program, the operator can obtain reports of rounds of play per hour per actual table, per pit, or per property, as determined by the user. The information in the form of a data stream may be further analyzed. In one example, the data is fed into a host computer or can be analyzed in the same computer system where the database and interface resides. For example, the data from one or more of the round counting module, the shoe sensor, the card swipe, card reading module, the shuffler data port sensor, and the bet interfaces can be used to create a report of rounds played per unit of time, the number of players at the table per unit of time, the number of hands played at each round, the maximum bet per player in a given unit of time, the average bet per player in a unit of time, the number of shuffles per unit of time, the number of cards removed from and placed into the shuffler in a unit of time, hand composition and other information considered important to the casino manager.

Because all of the G-Mod's work independently, the casino operator can choose the modules and resulting data that is most important to them, while saving valuable resources by only purchasing the sensing/data analysis packages they need. For example, one casino might want to reconstruct individual hands, track betting and associate the information with a particular player in a high stakes game, while tracking only rounds and the identification of the employees on low-stakes games.

By using a modular approach to data collection, only the equipment and reports that are wanted can be provided at the lowest possible cost. Since none of the G-Mod's are in command communication with one-another, it is not necessary to rewrite any code when additional modules are added.

All of the apparatus, devices and methods disclosed and claimed herein can be made and executed without undue experimentation in light of the present disclosure. While the apparatus, devices and methods of this invention have been described in terms of both generic descriptions and preferred embodiments, it will be apparent to those skilled in the art that variations may be applied to the apparatus, devices and methods described herein without departing from the concept and scope of the invention. More specifically, it will be apparent that certain elements, components, steps, and sequences that are functionally related to the preferred embodiments may be substituted for the elements, components, steps, and sequences described and/or claimed herein while the same of similar results would be achieved. All such similar substitutions and modifications apparent to those skilled in the art are deemed to be within the scope and concept of the invention as defined by the appended claims.

1. A casino table card gaming system in which a message is communicated from a subcomponent that receives casino employee identification information without date stamping to a first component that date stamps the signal and forwards the date stamped signal to a memory component that stores the date stamped signal, the system comprising a casino table, a casino employee identification component, a casino employee identification data receiver that sends an undated signal, and the first component that receives the undated signal.

2. The system of claim 1 wherein the data receiver is an employee identification card reader.

3. The system of claim 1 wherein the first component comprises a chipboard.

4. The system of claim 1 wherein the first component does not store signals or data contained in the signals after date stamping and forwarding the signals.

5. The system of claim 2 wherein the first component does not store signals.

6. The system of claim 3 wherein the first component does not store signals.

7. The system of claim 2 wherein the data receiver detects electromagnetic signals.

8. The system of claim 1 wherein date stamped signals are received by a central computer that creates data relating to location of a casino employee with respect to at least one specific casino table.

9. A method of detecting the location of a specific casino employee with respect to a specific casino table comprising automatically providing an original signal indicative of a casino table employee with respect to location of that casino table employee and the specific casino table, sending that signal without date stamping thereon to a first component on the table, the component date stamping the signal and then forwarding a date stamped signal to a memory component.

10. The method of claim 9 wherein the memory component provides stored signal information to a processor that interprets received date stamped signals to compute the location of a specific casino employee and a length of time that employee is present at the specific casino table, the time being based upon use of the date stamping received.

11. The method of claim 9 wherein the original signal contains no indication of date or time thereon.

12. The method of claim 9 wherein the original signal is provided by data provided through a system selected from the group consisting of electromagnetic radiation, optical reading, and bar code reading.

13. The method of claim 9 wherein the original signal is electromechanically read from a card carrying casino employee identification data.

14. The method of claim 10 wherein the processor determines changes of casino employee at the specific casino table, at least in part based upon evaluation of a time component in date stamped data the processor receives.

15. The method of claim 10 wherein results of play of a game at a specific casino table is compiled in association with at least one specific casino employee at the specific table as part of an employee rating process.

16. A hardware component on a casino card able that receives casino employee identification signals associated with a specific casino table without time stamped information thereon, adds time stamped information to the signals, and forwards the time stamped signal to a memory storage component.

17. The hardware component of claim 16 wherein the hardware component is constructed so that it cannot store time stamped signals after forwarding the time stamped signals.
